(19) United States
(12) Patent Application Publication
(10) Pub. No.: US 2010/0082509 A1
(43) Pub. Date: Apr. 1, 2010

(54) Self-Adapting Iterative Solver

(76) Inventors: Ilya Mishev, Pearland, TX (US); Sergey Nepmnyashchikh, Novosibirsk (RU); Alexandr Matsokin, Novosibirsk (RU)

Correspondence Address: Exxon Mobil Upstream;Research Company, P.O. Box 2189, (CORP-URC-SW 359), Houston, TX, 77252-2189, US

(21) Appl. No.: 12/505,292

(22) Filed: Jul. 17, 2009

Related U.S. Application Data
(60) Provisional application No. 61/101,490, filed on Sep. 30, 2008.

(51) Int. Cl. G06F 17/11; G06F 15/18

(52) U.S. Cl. 706/14; 703/2

(57) ABSTRACT

A self-adapting iterative solver is provided that employs a self-adapting process for extracting singularities for solving linear systems of equations. The self-adapting iterative solver dynamically determines how to adapt its performance in the presence of one or more singularities encountered in a linear system of equations. In certain embodiments, the self-adapting iterative solver can identify possible singularities, and then analyzes its performance for adapting to a treatment of the possible singularities that provides a desired performance (i.e., for achieving convergence to a solution). Thus, rather than being pre-configured for providing a certain treatment of (e.g., eliminating) certain pre-identified singularities, in certain embodiments, the iterative solver adapts its treatment of singularities based on its computing performance.

### CROSS-REFERENCE TO RELATED APPLICATION

This application claims the benefit of U.S. Provisional Patent Application 61/101,490 filed 30 Sep. 2008 entitled SELF-ADAPTING ITERATIVE SOLVER, the entirety of which is incorporated by reference herein.

### TECHNICAL FIELD

The following description relates generally to iterative solvers for solving linear systems of equations, and more particularly to a self-adapting iterative solver that is operable to adapt its performance in the presence of a singularity.

### BACKGROUND

Various techniques are known for solving linear systems of equations. Linear systems of equations are commonly encountered (and need to be solved) for various computer-based three-dimensional (“3D”) simulations or modeling of a given real-world system. For instance, such computer-based 3D modeling may employed for modeling such real-world systems as mechanical and/or electrical systems (such as may be employed in automobiles, airplanes, ships, submarines, space ships, etc.), human body (e.g., modeling of all or portions of a human's body, such as the vital organs, etc.), weather patterns, subsurface hydrocarbon bearing reservoirs (e.g., gas or oil fields), and various other real-world systems to be modeled. Through such modeling, potential future performance of the modeled system can be analyzed and/or predicted. For instance, the impact that certain changed conditions presented to the modeled system has on the system's future performance may be evaluated through interaction with and analysis of the computer-based model.

As an example, modeling of fluid flow in porous media is a major focus in the oil industry. Different computer-based models are used in different areas in the oil industry, but most of them include describing the model with a system of partial differential equations (PDE's). In general, such modeling commonly requires discretizing the PDE's in space and time on a given grid, and performing computation for each time step until reaching the prescribed time. At each time step, the discrete equations are solved. Usually the discrete equations are nonlinear and the solution process is iterative. Each step of the nonlinear iterative method typically includes linearization of the nonlinear system of equations (e.g., Jacobian construction), solving the linear system, and property calculations, that are used to compute the next Jacobian.

FIG. 1 shows a general work flow typically employed for computer-based simulation (or modeling) of fluid flow in a subsurface hydrocarbon bearing reservoir over time. The inner loop 101 is the iterative method to solve the nonlinear system. Again, each pass through inner loop 101 typically includes linearization of the nonlinear system of equations (e.g., Jacobian construction) 11, solving the linear system 12, and property calculations 13, that are used to compute the next Jacobian (when looping back to block 11). The outer loop 102 is the time step loop. As shown, for each time step loop boundary conditions may be defined in block 10, and then after performance of the inner loop 101 for the time step results computed for the time step may be output in block 14 (e.g., the results may be stored to a data storage media and/or provided to a software application for generating a display representing the fluid flow in the subsurface hydrocarbon bearing reservoir being modeled for the corresponding time step). As mentioned above, computer-based 3D modeling of real-world systems other than modeling of fluid flow in a subsurface hydrocarbon bearing reservoir may be performed in a similar manner, i.e., may employ an iterative method for solving linear systems of equations (as in block 12 of FIG. 1).

The solution of the linear system of equations is a very computationally-intensive task and efficient algorithms are thus desired. There are two big classes of linear solvers: 1) direct methods and 2) iterative methods. Direct methods generally rely on an efficient version of Gaussian elimination to factorize the matrix of the linear system. The solution is obtained by performing a backward solve followed by a forward solve. The factorization can be computationally and memory expensive because all new fill-in entries have to be computed and stored. The computational efficiency depends strongly on the size and the bandwidth of the matrix. Three-dimensional models lead to matrices that are very large, sparse, and with considerable bandwidth. The size and the large bandwidth lead to very big number of new fill-in entries that have to be calculated and stored. Thus, direct methods are generally still undesirably expensive, from both computational and memory viewpoints, to be used for real 3D modeling.

Iterative methods provide another approach for solving large sparse linear systems. When employing an iterative method, the solution is updated on every iteration until convergence is reached. Every iteration requires only operations with sparse matrices and is usually proportional to the number of unknowns. Unfortunately, standard iterative methods converge very slowly for large system of linear equations. This situation can be improved considerably by replacing the original matrix with a new one using the preconditioning matrix. For example, the original problem Ax=b may be replaced with the modified problem with the same solution: B⁻¹Ax=B⁻¹b, where B is the preconditioning matrix (or “preconditioner” for brevity). Every iteration with the modified matrix solves the problem with the matrix B, Bu=r.

There has been considerable progress in developing efficient preconditioners for elliptic and parabolic problems. A major achievement was the development of preconditioners that are computationally cheap (e.g., having the number of operations proportional to the number of unknowns) and efficient (e.g., having a small number of iterations that does not grow with the size of the problem). The best known examples of such preconditioners are MultiGrid and Domain Decomposition algorithms. Such preconditioners for which the number of iterations required for convergence does not increase as the size of the problem (or model) grows, may be referred to herein as “optimal preconditioners”.

A first well-known example of an optimal preconditioner is MultiGrid, which reduces the error by working on different components of the error on different grids.

A second well-known example of an optimal preconditioner is Domain Decomposition. Domain Decomposition algorithms compose the solution by solving the same or similar problem in parts of the original domain. Non-overlapping Domain Decomposition methods solve similar problems in each part of the domain, called sub-domains, Ω₁ and Ω₂, in the example of FIG. 2, and a different problem on the common interface γ.

Overlapping Domain Decomposition methods solve problems on extended domains that are formed from the original domain and overlapping strips as shown in FIG. 3. The solution of the global problem is composed by the solutions of the sub-domain problems.

Domain Decomposition algorithms can be applied in an additive or multiplicative way. The additive Domain Decomposition algorithms compute their parts of the solution simultaneously. Each step in the multiplicative methods includes several sub-steps. At the first sub-step, one group of sub-domains calculates the solution first. At the next sub-step, the next group of sub-domains uses the results of the first group to compute their solution, and so on.

Thus, such optimal preconditioners as MultiGrid and Domain Decomposition are known to be optimal if the model size grows. For instance, suppose a model starts with 100,000 cells, but at some later time a bigger model having a million cells is used, and then at some later time a model having an even higher dimension of 10 million cells is used. In general, an optimal preconditioner, such as MultiGrid or Domain Decomposition, may be employed and may converge to a solution in a fixed number of iterations, say 10 iterations, for all three models. Other preconditioners are known that require more iterations to converge as the model size increases, but the optimal preconditioners will generally converge in a fixed number of iterations irrespective of whether the size of the model increases.

Unfortunately, the performance of even the optimal preconditioners can considerably deteriorate if the original system of PDE's or the linear systems have some special features. For example, if the solution of the system of PDE's is extremely big in some part of the domain, or has no derivatives, difficulties may arise in solving the linear systems. Such behavior of the solution is usually referred to as “singularity.”

When modeling fluid flow in a subsurface hydrocarbon bearing reservoir, various special effects or features may exist in the subsurface region being modeled, such as wells, faults, or other geologic features, as examples. Such special effects or features present in the real-world system being modeled may give rise to a singularity. In general, a “singularity” refers to any feature in the linear system or the physical model that degrades the convergence of the iterative method (e.g., preconditioner) being used by the solver. For instance, the presence of a singularity may result in an optimal preconditioner failing to converge in an expected number of iterations. For example, as mentioned above, optimal preconditioners will generally converge in a fixed number of iterations irrespective of whether the size of the model increases. However, if a singularity is encountered in the model, then conventional optimal preconditioners, such as MultiGrid and Domain Decomposition, will fail to converge in the fixed number of iterations for the model.

Typically, singularities are caused either by the wells present in the modeling of a subsurface hydrocarbon bearing reservoir, or by discontinuous coefficients and their special behavior, such as rock properties in the subsurface being modeled. Wells are typically modeled as point or line sources and, in an area that has very small size (zero in the mathematical abstraction), some finite amount of fluid is either injected into the subsurface or produced (i.e., extracted from the subsurface) by the well. This causes the solution or its derivative to be extremely big (infinity in mathematical sense). Such behavior of the solution frequently leads to deterioration of the convergence of the preconditioned iterative methods. Many different well models are used in the oil industry. Most of them are not written as elliptic or hyperbolic equations. Consequently, the above-mentioned MultiGrid and Domain Decomposition methods are not very efficient for such linear systems.

Additionally, certain geologic features, such as faults, fractures or pinch-outs, may also cause problems for the preconditioned iterative methods. That is, certain geologic features may also give rise to a singularity which deteriorates the convergence of the preconditioned method. One reason that certain geologic features may cause problems is that the fluid flow in such geologic features can be very different from the flow in the surrounding porous media.

There have been many attempts to develop efficient preconditioners for linear systems as the ones considered above. As one example, preconditioners using Incomplete LU factorization are not affected by the presence of wells, faults or fractures, but are also not efficient for very large linear systems. As another example, techniques have been proposed for eliminating singularities in certain optimal preconditioners, such as in Domain Decomposition and MultiGrid. For instance, some Domain Decomposition methods have been attempted to eliminate the singularities, but the convergence was dependent on the overlap and deteriorated, see H. Cao, H. A. Tchelepi, J. Wallis, and H. Yardumian, “Parallel Scalable Unstructured CPR-Type Linear Solver for Reservoir Simulation”, SPE Annual Conference and Exhibition, October 2005, Dallas, Tex. MultiGrid methods were more successful, see K. Stuben, T. Clees, H. Klie, B. Lu, and M. F. Wheeler, Algebraic multigrid methods for the efficient solution of fully implicit formulations in reservoir simulation, SPE Reservoir Simulation Symposium, February 2007, Houston, Tex.; T. Clees, and L. Ganzer, An efficient multigrid solver strategy for adaptive implicit methods in oil reservoir simulation, SPE Reservoir Simulation Symposium, February 2007, Houston, Tex.; and H. Klie, M. F. Wheeler, K. Stuben, and T. Clees, Deflation AMG solvers for highly ill-conditioned reservoir simulation problems, SPE Reservoir Simulation Symposium, February 2007, Houston, Tex.

However, the above-mentioned proposed techniques for eliminating singularities in optimal preconditioners have failed to maintain the performance of the optimal preconditioners. For instance, suppose that an optimal preconditioner is expected to converge to a solution in, say 10 iterations, irrespective of the size of the model (assuming no singularity is encountered); the presence of a special feature in the model may give rise to a singularity that results in the optimal preconditioner instead requiring, say, 100 iterations to converge. Conventional techniques that have been proposed for eliminating the singularity may improve the performance of the optimal preconditioner such that it may converge in, say 25 iterations, but fails to achieve its expected performance (10 iterations in this example) that would be achieved if the special feature giving rise to the singularity were not present in the model.

Further, the above-mentioned proposed techniques for eliminating singularities rely on pre-identification of the presence of a singularity and follow a predefined regiment for eliminating any such pre-identified singularity. That is, the solver is pre-configured to eliminate a pre-identified singularity. Thus, users (e.g., engineers, analysts, etc.) are required to pre-identify special features in a model that are believed to likely give rise to a singularity, and the users pre-configure the solver to eliminate the pre-identified singularity. The solver itself is not utilized for identifying singularities, nor is the solver involved in determining whether to eliminate the pre-identified singularity. Instead, all such identifications of singularities and determinations regarding how to pre-configure the solver to eliminate the identified singularities are made external to the solver (e.g., by engineers, analysts, or other users).

### SUMMARY

The present invention is directed to a system and method which employ a self-adapting iterative solver. That is, an iterative solver is provided that employs a self-adapting process for extracting singularities for solving linear systems of equations. Thus, according to certain embodiments, a self-adapting iterative solver is provided, which is operable to determine how to adapt its performance in the presence of one or more singularities.

Thus, according to certain embodiments of the present invention, a self-adapting iterative solver is provided for solving linear systems of equations, such as commonly used for computer-based 3D modeling. In certain embodiments, the self-adapting iterative solver can identify possible singularities, and then analyzes its performance for adapting to a treatment of the possible singularities that provides a desired performance (i.e., for achieving convergence to a solution). Thus, rather than being pre-configured for providing a certain treatment of (e.g., eliminating) certain pre-identified singularities, in certain embodiments, the iterative solver adapts its treatment of singularities based on its computing performance.

For instance, an embodiment of the self-adapting iterative solver may attempt a first treatment of singularities (e.g., employing a first preconditioner for extracting certain singularities), and based on analysis of its computing performance (e.g., the number of iterations being required for convergence, and/or the computational cost of each iteration, etc.), the self-adapting iterative solver may adapt its treatment of singularities (e.g., by employing a different preconditioner for extracting singularities) to arrive at a technique for solving the linear system of equations in a manner that provides a desired performance. In adapting its performance, the self-adapting iterative solver may, in certain embodiments, extract fewer singularities than all of the pre-identified singularities and/or may identify additional singularities to extract. For instance, the self-adapting iterative solver may deduce that certain special effects or features present in the real-world system being modeled that were initially thought as possibly giving rise to a singularity do not actually result in a singularity that should be extracted for improved performance. As another example, during the course of its processing, the self-adapting iterative solver may detect further singularities (that were not pre-identified as possible singularities), which should be extracted to improve performance of the solver.

In certain embodiments, the self-adapting iterative solver adapts the preconditioner(s) used in the iterative solving process in order to treat singularities in a manner that provides a desired performance level. For instance, in certain embodiments, the self-adapting iterative solver constructs a preconditioner to extract certain singularities, and over the course of its processing the self-adapting iterative solver may modify/adapt its constructed preconditioner (e.g., to extract additional singularities that may be discovered and/or to not extract certain pre-identified possible singularities) for solving the linear system of equations.

In certain embodiments, the self-adapting iterative solver is an optimal solver that adapts its performance to treat singularities in a manner that maintains a number of iterations as would be encountered if the singularities were not present in the model. In certain embodiments, the self-adapting iterative solver may choose to adapt its performance in a manner that results in an increase in the number of iterations above the number of iterations that would be encountered if the singularities were not present in the model. However, such a self-adaptation for increasing the number of iterations may be performed intelligently by the self-adapting iterative solver (as opposed to resulting from a pre-configuration of the solver's operation). For instance, the self-adapting iterative solver may determine that it is more desirable in some instances to have an increase in iterations as opposed to having fewer iterations that are each extremely computationally expensive.

In certain embodiments, in analyzing its performance, the self-adapting iterative solver considers both the number of iterations and the computational expense of each iteration. For instance, in some cases a particular preconditioner may be employed for treating a singularity in a manner that greatly reduces the number of iterations for achieving convergence, but the computational expense (e.g., amount of CPU time and/or memory required) for processing each iteration may be very high. Thus, in some instances the self-adapting solver may conclude that a slight increase in the number of iterations in which each iteration is not so computationally expensive is an appropriate solution.

The relative importance of a given singularity may be based on one or more of various considerations, such as the corresponding amount of degradation in performance of the iterative solver resulting from the singularity (if the singularity were not extracted by a preconditioner). There are different possible ways to rank the singularities. One way of ranking is to assign different weights to the different singularities. In certain embodiments, the more important the singularity, the bigger the weight it is assigned. The self-adapting iterative solver may determine its treatment of possible singularities (e.g., determining a preconditioner for extracting select ones of the possible singularities) based at least in part on the relative weightings assigned to the singularities. The weightings assigned may, in certain embodiments, be updated by the self-adapting iterative solver over the course of its processing (e.g., based on the self-adapting iterative solver's evaluation of its performance in the presence of the singularities, etc.). In many instances, neglecting some of the low weighted possible singularities does not adversely influence the convergence of the iterative solver because the iterative method takes care of them.

Various exemplary techniques that may be employed by the self-adapting iterative solver for identifying possible singularities and self-adapting its treatment of those possible singularities based on its computational performance are described further herein. In certain embodiments, a two-step approach is employed by the self-adapting iterative solver for constructing a preconditioner. In such embodiments, the self-adapting iterative solver first attempts to construct a preconditioner from approximations available for the identified singularities. The self-adapting iterative solver may evaluate its performance for each such approximation, and determine those approximations for which the preconditioner's performance is unacceptable (e.g., either converges too slowly, has undesirable computational expense for each iteration, etc.). For those singularities for which an approximation is not available or for which the performance is determined to be unacceptable, the self-adapting iterative solver employs an alternative preconditioner construction technique, such as one based on representing the solution as a sum of the singular part and its complement. Exemplary preconditioner construction algorithms that may be employed in certain embodiments are described further herein.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows a general work flow typically employed for computer-based simulation (or modeling) of fluid flow in a subsurface hydrocarbon bearing reservoir over time;

FIG. 2 illustrates sub-domains that may be solved in non-overlapping Domain Decomposition methods;

FIG. 3 illustrates overlapping sub-domains that are solved in overlapping Domain Decomposition methods;

FIG. 4 shows a block diagram of an exemplary computer-based system implementing a self-adapting iterative solver according to one embodiment of the present invention;

FIG. 5 shows a block diagram of another exemplary computer-based system implementing a self-adapting iterative solver according to an embodiment of the present invention;

FIG. 6 shows a block diagram of another exemplary computer-based system implementing a self-adapting iterative solver according to an embodiment of the present invention;

FIG. 7 shows an exemplary operational flow of a self-adapting iterative solver for constructing a preconditioner according to one embodiment of the present invention;

FIG. 8 shows an exemplary operational flow of a self-adapting iterative solver for constructing a preconditioner for singularity(ies) for which an approximation is unavailable or is determined as unacceptable, according to one embodiment; and

FIG. 9 shows an exemplary computer system which may implement all or portions of a self-adapting iterative solver according to certain embodiments of the present invention.

### DETAILED DESCRIPTION

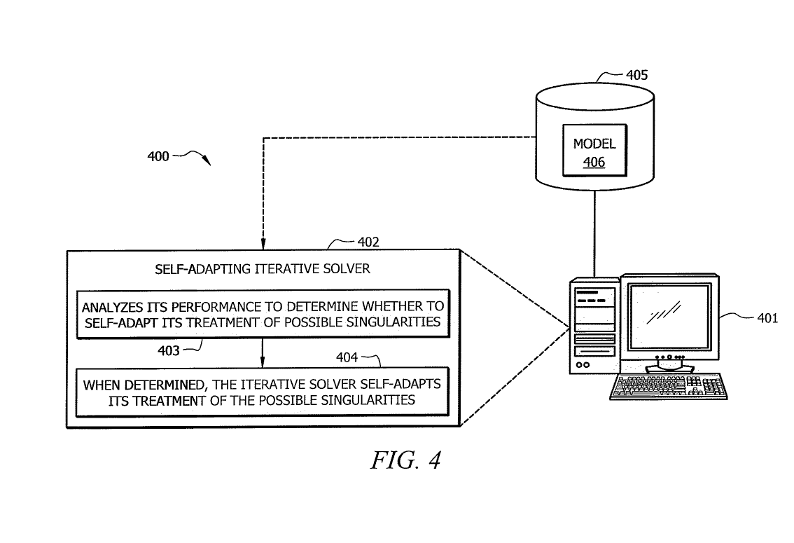

Turning to FIG. 4, a block diagram of an exemplary computer-based system 400 according to one embodiment of the present invention is shown. As shown, system 400 comprises a processor-based computer 401, such as a personal computer (PC), laptop computer, server computer, workstation computer, multi-processor computer, cluster of computers, etc. In addition, a self-adapting iterative solver (e.g., software application) 402 is executing on such computer 401. Computer 401 may be any computational device capable of executing a self-adapting iterative solver 402 as that described further herein. While self-adapting iterative solver 402 is shown as executing on computer 401 for ease of illustration in FIG. 4, it should be recognized that such solver 402 may be residing and/or executing either locally on computer 401 or on a remote computer (e.g., server computer) to which computer 401 is communicatively coupled via a communication network, such as a local area network (LAN), the Internet or other wide area network (WAN), etc. Further, it should be understood that computer 401 may comprise a plurality of clustered or distributed computing devices (e.g., servers) across which self-adapting iterative solver 402 may be stored and/or executed, as is well known in the art.

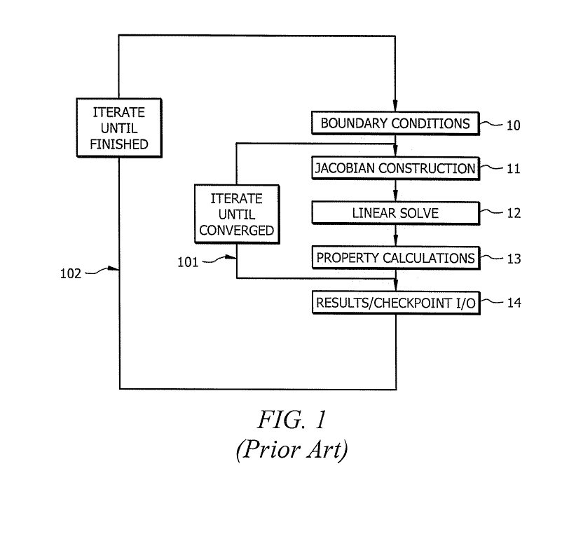

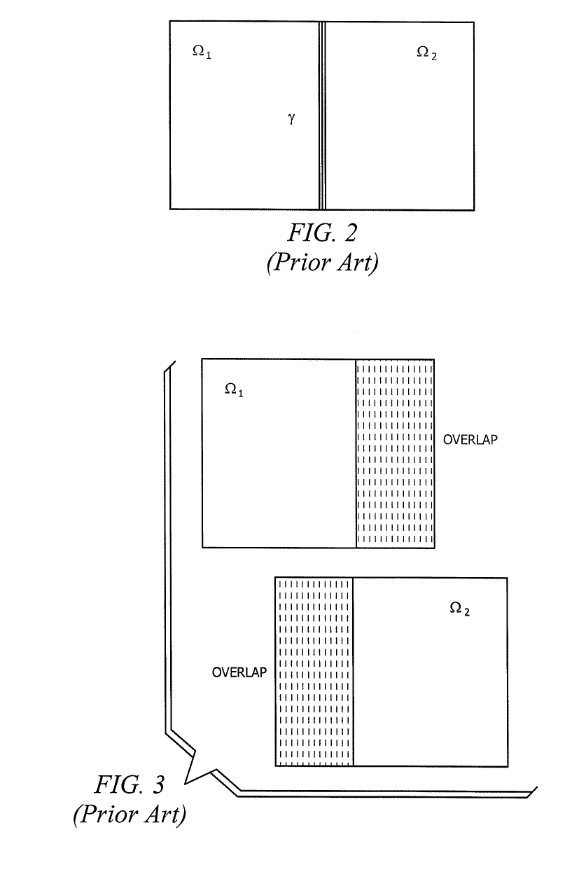

As with many conventional computer-based iterative solvers, self-adapting iterative solver 402 comprises computer-executable software code stored to a computer-readable medium that is readable by a processor of computer 401 and, when executed by such processor, causes computer 401 to perform the various operations described further herein for such self-adapting iterative solver 402. Self-adapting iterative solver 402 is operable to employ an iterative process for solving a linear system of equations. As discussed above, such iterative solvers are commonly used for 3D computer-based modeling. For instance, self-adapting iterative solver 402 may be employed in operational block 12 of the conventional work flow (of FIG. 1) for 3D computer-based modeling of fluid flow in a subsurface hydrocarbon bearing reservoir. In the illustrated example of FIG. 4, a model 406 (e.g., containing various information regarding a real-world system to be modeled, such as information regarding a subsurface hydrocarbon bearing reservoir for which fluid flow over time is to be modeled) is stored to data storage 405 that is communicatively coupled to computer 401. Data storage 405 may comprise a hard disk, optical disc, magnetic disk, and/or other computer-readable data storage medium that is operable for storing data.

As with the many conventional iterative solvers employed for 3D computer-based modeling, self-adapting iterative solver 402 is operable to receive model information 406 and perform an iterative method for solving a linear system of equations for generating a 3D computer-based model, such as a model of fluid flow in a subsurface hydrocarbon bearing reservoir over time.

According to an embodiment of the present invention, self-adapting iterative solver 402 is operable to analyze, as shown in block 403, its computational performance to determine whether to self-adapt its treatment of possible singularities in the model 406. As shown in block 404, when so determined that it should self-adapt its treatment of possible singularities in the model, the self-adapting iterative solver 402 self-adapts its treatment of the possible singularities to improve its performance in solving the linear system of equations for the 3D computer-based modeling. For instance, self-adapting iterative solver 402 may adapt its use of preconditioner(s) for extracting different ones of possible singularities in order to attain a desired computational performance.

Thus, rather than being restricted to performing some pre-configured elimination of pre-identified singularity(ies), embodiments of self-adapting iterative solver 402 are operable to self-adapt their treatment of singularities. As one example, self-adapting iterative solver 402 may be an optimal solver that is expected to converge in a given number of iterations, say 10 iterations, irrespective of the size of model 406. However, due to encountering certain singularities in model 406, the performance of self-adapting iterative solver 402 may be degraded to result in requiring more than 10 iterations to converge, unless the self-adapting iterative solver 402 adapts its treatment of such singularities. In certain embodiments, self-adapting iterative solver 402 adapts its treatment of the singularities (e.g., by constructing preconditioner(s) for extracting select ones of the identified possible singularities) so as to arrive at a processing technique that converges in the desired 10 iterations. As mentioned above, in certain embodiments, self-adapting iterative solver 402 may intelligently choose to employ a processing technique that increases the number of iterations for convergence (e.g., more than 10 in the above example), if the computational expense of each iteration would otherwise be deemed too expensive. Various exemplary ways in which embodiments of self-adapting iterative solver 402 may evaluate its performance and adapt its treatment of singularities are discussed further herein.

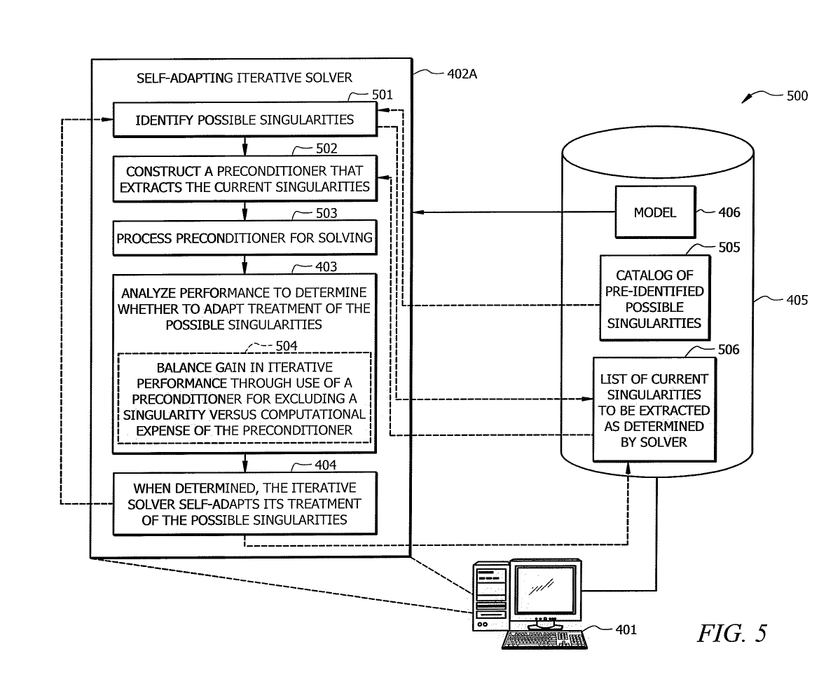

Turning to FIG. 5, a block diagram of another exemplary computer-based system 500 according to an embodiment of the present invention is shown. As with exemplary system 400 of FIG. 4, system 500 comprises a processor-based computer 401 on which an embodiment of a self-adapting iterative solver 402, shown as self-adapting iterative solver 402A in this example, is executing. Also, as in the example of FIG. 4, a model 406 (e.g., containing various information regarding a real-world system to be modeled, such as information about a subsurface hydrocarbon bearing reservoir for which fluid flow over time is to be modeled) is stored to data storage 405 that is communicatively coupled to computer 401. As discussed above, self-adapting iterative solver 402A is operable to receive model information 406 and perform an iterative method for solving a linear system of equations for generating a 3D computer-based model, such as a model of fluid flow in a subsurface hydrocarbon bearing reservoir over time, as may be employed in block 12 of the exemplary flow of FIG. 1.

In the exemplary embodiment of FIG. 5, self-adapting iterative solver 402A identifies possible singularities in block 501. Possible singularities in the model may be identified in various ways. For instance, certain possible singularities may be pre-identified (e.g., by users, such as engineers, analysts, etc.) based on known information about the real-world system being modeled, and the pre-identified possible singularities for model 406 may be cataloged (stored) to a catalog 505 (e.g., any appropriate computer-readable data structure, such as a file, database, etc.), which is stored to data storage 405. Thus, various features known to exist in the real-world system being modeled that are suspected to give rise to a singularity may be pre-identified in catalog 505. For example, in modeling of fluid flow in a subsurface hydrocarbon bearing reservoir, common features that may give rise to a singularity in the model, which may be pre-identified in the target area to be modeled may include the presence of certain geologic features (e.g., faults, large fractures, pinch-outs, etc.) and/or certain engineered features (e.g., horizontal, slanted, and vertical wells, connected facility network, etc.).

In addition, in certain embodiments self-adapting iterative solver 402A may itself discover some possible singularities during its processing of the model. For instance, during processing, solver 402A may identify possible singularities through its analysis of the equations (e.g., matrices) being processed. For example, abnormal matrix entries or constructions (e.g., extremely large entries, a matrix that is not diagonally dominant, positive off-diagonal entries in a M-matrix, etc.) for a given modeling process may be recognized by the self-adapting iterative solver 402A as a possible singularity being present in the corresponding portion of the model.

In certain embodiments, self-adapting iterative solver 402A maintains a list 506 (which may be in the form of any appropriate computer-readable data structure, such as a file, database, etc.), which is stored to data storage 405, where such list 506 identifies the current singularities that self-adapting iterative solver 402A is to extract. Exemplary techniques that may be employed for extracting the singularities are discussed further herein below. In one embodiment, as possible singularities are identified in block 501, they are added to the list 506 of current singularities to be extracted. Of course, as discussed further herein, the list 506 is dynamic and may be modified by self-adapting iterative solver 402A as it determines how best to adapt its treatment of singularities for providing a desired level of performance. As further described herein, in certain embodiments, the list of current singularities and/or catalog of pre-identified possible singularities may include respective weightings assigned to the singularities.

In block 502, the self-adapting iterative solver 402A constructs a preconditioner that extracts the current singularities (i.e., those singularities identified on list 506). Initially, this list 506 may include all possible singularities pre-identified in catalog 505. As discussed further herein, in some instances one or more of such possible singularities may be removed from the current list 506 (such that they are not extracted) and/or one or more possible singularities discovered by the self-adapting iterative solver 402A (e.g., through analysis of the matrices being processed) may be added to the current list 506. Again, exemplary techniques that may be employed in block 502 for constructing a preconditioner for extracting selected singularities (i.e., those on the current list 506) are discussed further herein below. A determination of singularities to be included on current list 506 (for extraction by a preconditioner) and those to be removed from the list 506 may be based, in certain embodiments, at least in part on the relative weightings assigned to the singularities. For instance, singularities assigned a high weighting may be deemed to have a high degradation on performance of the iterative solver if not extracted, and those assigned a low weighting may be deemed to have a lower degradation on performance of the iterative solver; in which case, those singularities having the highest weighting may be selected for inclusion on the current list 506 for extraction by a preconditioner.

In block 503, the self-adapting iterative solver 402A uses the constructed preconditioner in its iterative solving of the linear system of equations for determining the corresponding portion of the 3D computer-based model. Exemplary preconditioners that may be employed in certain embodiments, and their use for iterative solving of the linear system of equations, are described further herein. Of course, embodiments of the present invention are not limited to use of any particular preconditioners, but instead certain embodiments may be implemented to self-adapt for application of any of various different preconditioners.

In block 403, self-adapting iterative solver 402A analyzes its performance to determine whether to self-adapt its treatment of possible singularities in the model. While shown as a linear flow for ease of illustration in FIG. 5, it should be recognized that the various operations are not restricted to the order in which they are shown and certain ones of the blocks may be performed in parallel. For instance, in certain embodiments, while processing the constructed preconditioner in block 503, self-adapting iterative solver 402A may analyze its performance to determine whether to adapt its treatment of singularities. When so determined that it should self-adapt its treatment of possible singularities, the self-adapting iterative solver 402A self-adapts its treatment of the possible singularities in block 404. It may, in some instances, interrupt its processing in block 503 before the iterative process of block 503 converges to a solution, in order to self-adapt its treatment of possible singularities in block 404.

In certain embodiments, as part of the analysis in block 403, self-adapting iterative solver 402A balances, in block 504, a gain in iterative performance (e.g., reduction in number of iterations for convergence) obtained through use of a preconditioner for excluding select singularities (on list 506) versus the computation expense of the preconditioner in each iteration. For example, in analyzing its performance in block 403, self-adapting iterative solver 402A may consider both the number of iterations for convergence and the computational expense of each iteration. For instance, in some cases a particular preconditioner may be employed for treating the current singularity(ies) (from list 506) in a manner that greatly reduces the number of iterations for achieving convergence, but the computational expense (e.g., amount of CPU time and/or memory required) for processing each iteration may be very high. Thus, in some instances, self-adapting iterative solver 402A may conclude, in block 504, that a slight increase in the number of iterations in which each iteration is not so computationally expensive is an appropriate solution.

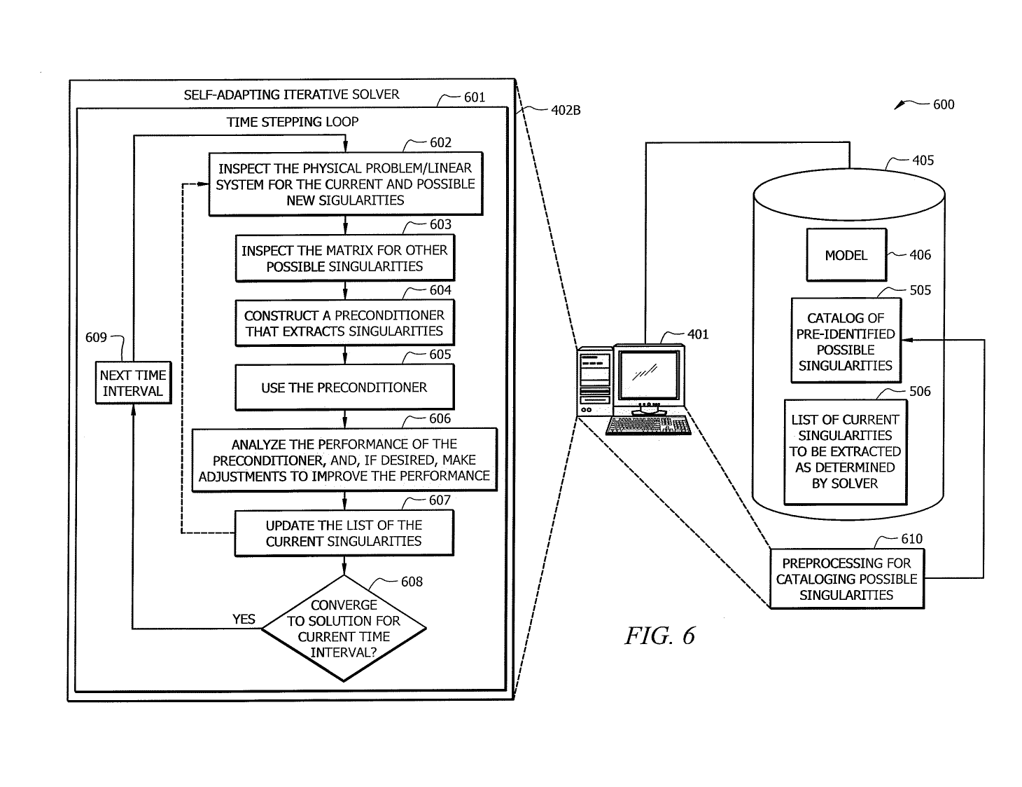

Turning to FIG. 6, a block diagram of another exemplary computer-based system 600 according to an embodiment of the present invention is shown. As with exemplary systems 400 of FIGS. 4 and 500 of FIG. 5, system 600 comprises a processor-based computer 401 on which an embodiment of a self-adapting iterative solver 402, shown as self-adapting iterative solver 402B in this example, is executing. Also, as in the example of FIG. 5, a model 406 (e.g., containing various information regarding a real-world system to be modeled, such as information about a subsurface hydrocarbon bearing reservoir for which fluid flow over time is to be modeled), a catalog 505 of pre-identified possible singularities, and list 506 of current singularities to be extracted are stored to data storage 405 that is communicatively coupled to computer 401. As discussed above, self-adapting iterative solver 402B is operable to receive model information 406 and perform an iterative method for solving a linear system of equations for generating a 3D computer-based model, such as a model of fluid flow in a subsurface hydrocarbon bearing reservoir over time, as may be employed in block 12 of the exemplary flow of FIG. 1.

In the exemplary embodiment of FIG. 6, self-adapting iterative solver 402B may be used in a work flow such as that described above in FIG. 1. For instance, self-adapting iterative solver 402B may be used in a time stepping loop 601, such as the exemplary outer loop 102 of FIG. 1, wherein various operations discussed hereafter may be performed in the time stepping loop 601.

In block 602, the physical problem (e.g., model 406 and/or the corresponding real-world system) and/or the linear system is inspected to identify current and possible new singularities. Possible singularities in the model may be identified in various ways. For instance, certain possible singularities may be pre-identified (e.g., by users, such as engineers, analysts, etc.) based on known information about the real-world system being modeled, and the pre-identified possible singularities for model 406 may be cataloged (stored) to a catalog 505 (e.g., any appropriate computer-readable data structure, such as a file, database, etc.), which is stored to data storage 405. That is, certain pre-processing 610 may be performed for initially populating catalog 505 with pre-identified possible singularities. Thus, various features known to exist in the real-world system being modeled that are suspected to give rise to a singularity may be pre-identified in catalog 505. For example, in modeling of fluid flow in a subsurface hydrocarbon bearing reservoir, common features that may give rise to a singularity in the model, which may be pre-identified in the target area to be modeled may include the presence of certain geologic features (e.g., faults, large fractures, pinch-outs, etc.) and/or certain engineered features (e.g., horizontal, slanted, and vertical wells, connected facility network, etc.).

In this exemplary embodiment, in every time step of time stepping loop 601, the linear system is examined for the current singularities and possible new singularities due to the changes in the physical system, such as wells being turned on and off, switching from primary production to water or gas displacement, and/or other changes occurring within a subsurface hydrocarbon bearing reservoir being modeled. In the beginning, all cataloged possible singularities are checked. That is, the self-adapting iterative solver may evaluate each of the possible singularities cataloged in catalog 505 to determine whether they are actual singularities (i.e., whether their presence actually degrades the convergence of the iterative method employed by the solver 402B), and those determined to be actual singularities that degrade performance of the iterative method to some extent are added to the list 506 of current singularities to be removed.

In addition, in block 603, self-adapting iterative solver 402B may itself discover some possible singularities based on its inspection of the matrices being processed for the model 406. For example, abnormal matrix entries or constructions (e.g., extremely large entries, a matrix that is not diagonally dominant, positive off-diagonal entries in a M-matrix, etc.) for a given modeling process may be recognized by the self-adapting iterative solver 402B as a possible singularity being present in the corresponding portion of the model.

In certain embodiments, self-adapting iterative solver 402B maintains a list 506 (which may be in the form of any appropriate computer-readable data structure, such as a file, database, etc.), which is stored to data storage 405, where such list 506 identifies the current singularities that self-adapting iterative solver 402B is to extract. Initially, this list 506 may include all possible singularities pre-identified in catalog 505 and determined in block 603. However, the list 506 of current singularities to be extracted is dynamic and thus may be adjusted by self-adapting iterative solver 402B over the course of processing of model 406.

In block 604, the self-adapting iterative solver 402B constructs a preconditioner that extracts the current singularities (i.e., those singularities identified on list 506). As discussed further herein, in some instances one or more of such possible singularities may be removed from the current list 506 (such that they are not extracted) and/or one or more possible singularities discovered by the self-adapting iterative solver 402B (e.g., through analysis of the matrices being processed) may be added to the current list 506. Again, exemplary techniques that may be employed in block 604 for constructing a preconditioner for extracting selected singularities (i.e., those on the current list 506) are discussed further herein below.

In block 605, the self-adapting iterative solver 402B uses the constructed preconditioner in its iterative solving of the linear system of equations for determining the corresponding portion of the 3D computer-based model. Exemplary preconditioners that may be employed in certain embodiments, and their use for iterative solving of the linear system of equations, are described further herein. Of course, embodiments of the present invention are not limited to use of any particular preconditioners, but instead certain embodiments may be implemented to self-adapt for application of any of various different preconditioners.

In block 606, self-adapting iterative solver 402B analyzes performance of the preconditioner, and if desired, makes adjustments to the preconditioner to improve the solver's computational performance. In block 607, the list 506 of the current singularities may be updated to, for example, reflect any changes in the singularities that are to be extracted, as determined in block 606. While shown as a linear flow for ease of illustration in FIG. 6, it should be recognized that the various operations are not restricted to the order in which they are shown and certain ones of the blocks may be performed in parallel. For instance, in certain embodiments, while processing the constructed preconditioner in block 605, self-adapting iterative solver 402B may analyze its performance (block 606) to determine whether to adapt its treatment of singularities. When so determined that it should self-adapt its treatment of possible singularities, the self-adapting iterative solver 402B self-adapts its treatment of the possible singularities by updating (in block 607) the list 506 of current singularities to be extracted. It may, in some instances, interrupt its processing in block 605 before the iterative process of block 605 converges to a solution, in order to self-adapt its list 506 of current singularities to be extracted in block 607, wherein its operation may thereafter return to block 602 to eventually construct (in block 604) another preconditioner for extracting the revised current list 506 of singularities.

When determined in block 608 that the self-adapting iterative solver 402B has converged to solution for the current time interval of the model that is being processed, the operation may advance, in block 609, to the next time interval to be processed, just as in the outer loop 102 of the exemplary work flow of FIG. 1.

Not all of the singularities impact the linear system in a bad way all of the time. For example, if a well is shut-in in a subsurface hydrocarbon bearing reservoir being modeled, there is no influence on the linear system. In this exemplary embodiment, the self-adapting iterative solver 402B may investigate each possible singularity (physically bounded) by taking a small patch of the model and analyzing the corresponding linear system and its solution. If there is some abnormal behavior, either of the linear system (like large condition number) or its solution, then the singularity is selected for extraction (i.e., added to the list 506 of current singularities). Otherwise, the possible singularity is not included (i.e., may be removed from) the list 506 for the current time step. Frequently, it is enough just to check if there are changes in the model 406. For example, if a well is producing and it used to cause problems for the linear system, it may be assumed that it will continue to do so.

In one embodiment, the performance analysis (e.g., of block 403 of FIG. 4 or block 606 of FIG. 6) inspects the behavior of the iterative solver to try to improve iterative performance and/or CPU/Wall clock performance of the self-adapting iterative solver. Iterative performance may be improved through adding neglected singularities, discovering new singularities, and/or improving the treatment of the current singularities. CPU/Wall clock performance may be improved by adjusting the preconditioner's operation in certain embodiments. For instance, if the iterative performance is good, but the preconditioner becomes computationally expensive, the self-adapting iterative solver may, in certain embodiments, choose to neglect some of the singularities and/or relax the treatment of certain singularities.

Ideally, improving the iterative performance should improve the CPU/Wall clock performance, but that is not always the case. Making the preconditioner very expensive, i.e., “too good”, can lead to a few but very expensive iterations. Making the preconditioner very cheap, but not efficient generally does not provide a good solution either. One way employed by certain embodiments for achieving a compromise is to rank the current singularities by importance and keep the most important, i.e., with the highest rank. One possible way is to give weights to different singularities and the bigger the weight the higher the rank. The weights are updated during the simulation run and the changes reflect the performance. Neglecting some of the low-order singularities frequently does not influence adversely the convergence because the iterative method takes care of them.

There are several approaches that may be employed for assigning weights to different singularities. One approach that may be employed in accordance with certain embodiments is to assign static weights based on the type of the singularity. For example, vertical wells may be assigned a weight of 1, slanted wells may be assigned a weight of 2, horizontal wells may be assigned a weight of 3, etc. These static weights may be based on analysis of results from previous runs (processed with some statistical tools) and/or may be based on application of some theoretical assumptions. A more sophisticated approach that may be employed in accordance with certain embodiments is to dynamically adapt the weights based on the performance of the iterative solver. For instance, this approach may start with fixed weights used on a first run (e.g., a first 3D modeling employing the iterative solver), and on a next run some of the weights may be changed and the corresponding performance of the iterative solver analyzed. For example, the approach may solve a linear system of equations once with weightings assigned as: 3 for a first horizontal well, and 3 for a second horizontal well. Next, the linear system of equations may be solved with weight 2 assigned to the first horizontal well and weight 4 assigned to the second horizontal well. The performance of the first and second iterative methods may be compared, and the approach may continue adjusting the weights based on the determined performance comparisons. It may turn out, for instance, that the first well is not important and it can be dropped from the current list of singularities. By employing an approach in which only a fixed number of singularities with the highest assigned weights are taken into account, for example, the first well may drop out of the current list of singularities once this approach lowers its relative weighting sufficiently.

Various different algorithms may be employed for extracting singularities. Different singularities can require different methods for extraction. As one exemplary algorithm that may be employed, consider singularities that are bounded physically, such as a singularity encountered in a portion of a model of fluid flow in a subsurface hydrocarbon bearing reservoir that is bounded physically. In one embodiment, it is supposed that the fluid behavior in and around a given singularity can be approximated with a simpler model, and this simpler model does not impact adversely the linear system. For example, complicated well models usually impact adversely the quality of the preconditioner. Simple well models behave much better. If the complicated well models can be approximated with simple well models, then the resulting preconditioner is expected to be much better. Sometimes, the approximation cannot solve the problem, but the dimension of the “bad” part is considerably reduced. In one embodiment, a second step is applied that involves a special small rank update procedure. A similar approach can be used for geologic singularities like fractures that may be encountered in the subsurface hydrocarbon bearing reservoir being modeled.

According to one embodiment, two preconditioners are considered for identified physically-bounded singularities. Initially, for each physically-bounded singularity, a sub-domain is chosen that contains the singularity and small strip around it. An exemplary two-step process that may be employed for constructing a preconditioner to be used for such a singularity in certain embodiments is discussed below. That is, in certain embodiments the exemplary two-step approach described below is employed for constructing a preconditioner (e.g., in block 604 of FIG. 6).

First, each singularity is replaced with an appropriate approximation (e.g., which may be performed as part of block 604 of FIG. 6). A global preconditioner is then constructed (e.g., which may be performed as part of block 604 of FIG. 6), wherein the global preconditioner comprises the original problem outside the singularities and the determined approximation inside the singularities. In certain embodiments, an Additive or Multiplicative Schwarz may be applied with the global preconditioner and the sub-domains. Overlapping or non overlapping versions can be used.

The quality of the approximation of a given singularity is then evaluated (e.g., which may be performed as part of block 606 of FIG. 6). For instance, the quality of the approximation may be evaluated either using a local patch that contains it and examining the linear system, or observing the convergence behavior of the preconditioner. That is, the given singularity can be approximated, and the linear solve can be performed on the approximation. Whether the convergence is acceptable when using the approximation is then determined. If determined that the convergence is not acceptable, then the alternative preconditioner construction technique discussed below is used in the next time step (e.g., following the next time interval 609 in the exemplary time stepping loop of FIG. 6).

In the alternative preconditioner construction technique of this exemplary embodiment, another preconditioner is used when there is no available good approximation, or the approximation still impacts adversely the linear system. In one embodiment, the solution is computed as a sum of two terms. The first is the orthogonal projection into the “singularity space,” and the second is its complement. Any preconditioner for the “good part” can be used including the one in the previous step.

A given singularity may be viewed as contained in a singularity space, which may include certain features/characteristics that can be approximated well and may also include certain other features/characteristics for which a good approximation is not available. According to certain embodiments, the singularity space may be divided into a portion that can be approximated well (which may be referred to as a “good” part) and a portion that cannot be approximated well (which may be referred to as a “bad” part). Accordingly, in certain embodiments, the self-adapting iterative solver is operable to extract the “bad” part from a singularity space, thereby resulting in a remaining good part that can be approximated well.

A given singularity space “X” can be considered as having a corresponding dimension (corresponding to the size of the submatrix that describes the singularity), say dimension “dim(X)”. The solver may first attempt to approximate the singularity with a simpler model having a reduced dimension, say in a space “Y” with dimension “dim(Y)” (wherein dim(Y)<dim(X)). The space “Y” is a part of the singularity space “X”. A portion of the singularity that is not approximated well may remain. This portion is in a space “Z” with dimension “dim(Z), where “dim(Z)=dim(X)−dim(Y)”, i.e. what is left from the singularity space after we have taken out “Y”. In certain embodiments, the approximated portion in the space “Y” of the singularity space is considered a “good” part of the singularity space, which may be treated using an appropriate preconditioner, while the remaining “Z” portion of the singularity space is referred to as a “bad” part of the singularity space that may be treated in a different manner. Thus, according to certain embodiments, for any singularities for which an approximation is not available (as determined in block 701) or for which the quality of the approximation is determined unacceptable (in block 703), the self-adapting iterative solver 402 attempts to extract the “bad” part. Thus, when an appropriate approximation is not available for a given singularity or the quality of such an approximation is unacceptable, in certain embodiments the solver extracts a “bad” part of the singularity such that the remaining good part can be modeled by an approximation that is acceptable.

Suppose, as an example, that the original problem has dimension 1,000,000 and there is a singularity with dimension 100. Further suppose that the solver attempts to approximate this singularity with a simpler one having a dimension of, say, 90. If the performance of a first preconditioner is determined as acceptable, it is used. Otherwise, if the performance of the first preconditioner is determined as unacceptable, then the second step discussed further herein is employed. Conceptually, with the approximation of the singularity, some of the 100 singularity modes are suppressed, say 90 of the singularity modes may be suppressed by the approximation. The 10 remaining singularity modes are referred to as the “bad” modes (or “bad” part) remaining to be taken care of Unfortunately, we do not know explicitly which they are. In this example, the “bad”, or the singularity part will have dimension 10, and the “good” part, 1,000,000−10. Further, in this example, the number of iterations to remove the “bad” part will be proportional to 10, such as O(10). In general, we may use only the second algorithm, but the amount of computations depends on the number of the “bad” modes, and it is computationally more efficient first to approximate and decrease the number of not resolved modes. Thus, improved performance may be achieved through the recognition of the “good” and “bad” parts of the identified singularity space, and treating each of the good and bad parts appropriately, such as discussed further herein.

Thus, according to certain embodiments the self-adapting iterative solver is operable to, responsive to identifying a singularity, determine whether an acceptable approximation is available for the singularity. If there is a good approximation available, then a corresponding preconditioner for the approximation is used for iteratively solving the singularity. When determined that there is not an acceptable approximation available (i.e., either there is no available good approximation or an approximation is determined to still adversely impact the linear system), then the iterative solver extracts a bad portion of the singularity to result in a remaining good portion of the singularity for which a good approximation is available. An appropriate preconditioner for the approximation of the good portion of the singularity is then used for iteratively solving the good portion of the singularity. In certain embodiments, the extracted bad portion of the singularity may be treated differently. The treatment of the bad portion of the singularity may be computationally less efficient than the treatment of the good portion, but overall the computationally is improved as a result of extracting from the singularity the “bad” portion, thereby enabling the “good” portion to be iteratively solved in a computationally efficient manner.

Now, consider groups of singularities that are difficult to isolate physically, but they can be isolated in some other manner. For example, if there are only a few isolated eigenvalues of the preconditioned system, deflation may be used. For more information regarding deflation, see R. Nabben and C. Vuik, “A Comparison of deflation and Coarse grid correction applied to porous media flows,” SIAM H. Numer. Anal., v. 42, 1631-1647; and see J. Frank and C. Vuik, “On the construction of deflation-based preconditioners,” SIAM J. Sci. Comput., v. 23, 442-462. In general, it is more difficult to check for the existence of such singularities. In certain embodiments, their existence is deduced from the iterative behavior of the preconditioner.

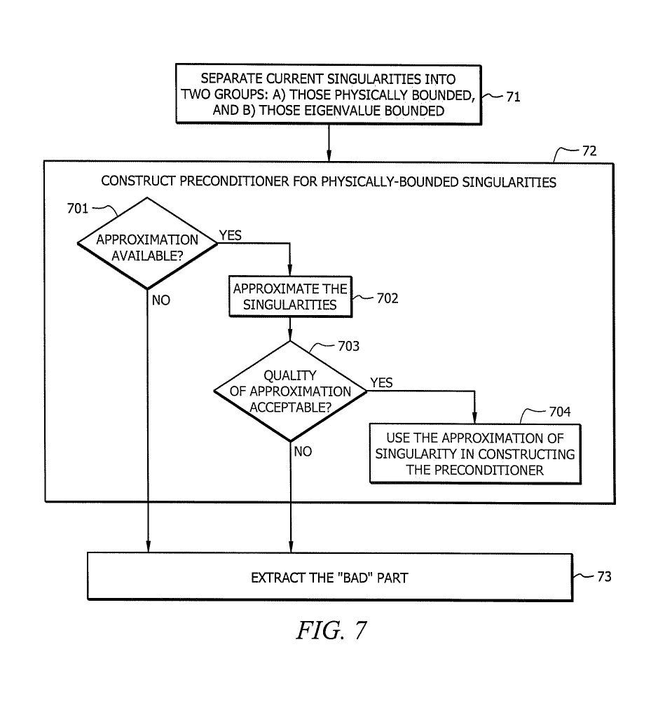

Thus, an exemplary workflow for constructing a preconditioner (e.g., in block 604 of FIG. 6) according to one embodiment of self-adapting iterative solver 402 is described further with FIG. 7. In block 71, self-adapting iterative solver 402 separates current singularities into two groups: a) physically bounded, and b) eigenvalue bounded. In one embodiment, the eigenvalue bounded singularities are more general and include the physically bounded singularities. The algorithms for the physically bounded singularities are generally easier to implement, and are usually more efficient. If there only a few eigenvalues that are not suppressed, the deflation algorithm can help, although they are more difficult to implement and could be computationally expensive. An example of a physical feature that can lead to a problem (not suppressed eigenvalue) is a layer with drastically different properties in the porous media of a subsurface hydrocarbon bearing reservoir being modeled. Such problems can be identified by the users who build the models or, for very complex models, by pattern recognition algorithms. There are efficient deflation algorithms for such simplified cases.

The self-adapting iterative solver 402 attempts to construct a preconditioner for the physically bounded singularities in block 72. For the physically bounded singularities, the self-adapting iterative solver 402 determines in block 701, for each physically-bounded singularity, whether an approximation of the singularity is available. For those singularities for which an approximation is available, the approximation(s) are used for approximating the singularity(ies), in block 702. The self-adapting iterative solver 402 evaluates the quality of the approximation (e.g., determines whether the convergence is acceptable, as discussed above) in block 703. For each singularity whose quality is determined to be acceptable in block 703, the approximation of such singularity is used in the construction of the preconditioner, as shown in block 704.

For any singularities for which an approximation is not available (as determined in block 701) or for which the quality of the approximation is determined unacceptable (in block 703), the self-adapting iterative solver 402 attempts to extract the “bad” part (e.g., using the second algorithm discussed further below) in block 73.

Conventionally, a self-adapting approach for constructing a preconditioner, such as the exemplary approach of FIG. 7, has not been employed by iterative solvers. Rather, conventional iterative solvers may be pre-configured to utilize an approximation of singularities or to use deflation for constructing a preconditioner, but conventional iterative solvers have not been self-adapting to potentially employ either or both construction techniques, such as employed in the exemplary approach of FIG. 7. A pre-configured approach implemented for conventional iterative solvers often fails to provide a desired computational performance, and certain embodiments of a self-adapting iterative solver as described herein may self-adapt its approach for constructing preconditioners (such as discussed in the above example of FIG. 7) in order to improve the computational performance.

According to one embodiment, the convergence of an iterative method for a given matrix A is determined by the distribution of the eigenvalues (at least for symmetric matrices). Suppose the eigenvalues are between the numbers a=1 and b=1,000,000. Then, the number of iterations in the iterative solver should be proportional to the square root of (b/a)˜1000. To improve the convergence, in certain embodiments, a preconditioner is introduced as B⁻¹A, which may reduce the number of eigenvalues. For instance, continuing with the above example, the eigenvalues of B⁻¹A may be between c=1 and d=100. Then, the number of iterations of the iterative solver for processing the preconditioner is proportional to square root of (d/c).

In general, MultiGrid and domain decomposition algorithms “move” the eigenvalues to the left-hand side of the spectrum and improve the convergence of an iterative solver. However, if there are singularities present, their eigenvalues are not touched (i.e., not moved to the left-hand side of the equation). According to certain embodiments of the present invention, algorithms are employed to “move” the untouched eigenvalues. The deflation algorithms mentioned herein may also be employed in some instances to “move” the eigenvalues to the left, but they need to have an approximation of the eigenvectors, which is rarely available. For this reason, the deflation algorithms are generally considered as a last resort in certain embodiments. In some well-studied cases, such as layer of the porous media with drastically different properties, this can be done efficiently.

Exemplary preconditioners that may be constructed according to certain embodiments are now briefly discussed. That is, exemplary algorithms may be employed for constructing a preconditioner according to certain embodiments are discussed further below. Of course, embodiments of the present invention are not limited to use of the exemplary preconditioner construction algorithms described below.

First, an algorithm that may be employed for constructing a preconditioner based on an approximation of one or more singularities is discussed. Thus, this exemplary algorithm may be employed in block 72 of FIG. 7. Consider the matrix

$$A = [ \begin{matrix}{A}_{11} & {A}_{12} & 0 \\ {A}_{21} & {A}_{22} & {A}_{23} \\ 0 & {A}_{32} & {A}_{33}\end{matrix} ] ,$$

where the block A₃₃ corresponds for the singularities, A₂₂ is the strip around them, and A₁₁ is the rest. Suppose we can approximate A₃₃ with another matrix Ā₃₃. Then, the overlapping additive version of the first preconditioner is: M⁻¹u=M_{RS}⁻¹u+M_{W}⁻¹u,

$$where {M}_{RS}^{- 1} = {[ \begin{matrix}{A}_{11} & {A}_{12} & 0 \\ {A}_{21} & {A}_{22} & {A}_{23} \\ 0 & {A}_{32} & {\overline{A}}_{33}\end{matrix} ]}^{- 1} , {M}_{W}^{- 1} = {[ \begin{matrix}{A}_{22} & {A}_{23} \\ {A}_{32} & {A}_{33}\end{matrix} ]}^{- 1} .$$

That is, the action of the preconditioner M⁻¹ has two independent steps that can be executed independently (even in parallel if parallel processing is used). The first one is solving: (1) M_{RS}x_{RS}=u; and the second one is solving: (2) M_{W}x_{W}=u. Then, the action of the preconditioner M⁻¹ on the vector u is the defined by M⁻¹u=x_{RS}+x_{W}.

The exact solves above, i.e., (1) and (2), can be replaced with any available preconditioner. If the approximation matrix Ā₃₃ has different dimension, then it may be restricted and interpolated, such as follows:

$${M}_{RW}^{- 1} = {[ \begin{matrix}I & 0 & 0 \\ 0 & I & 0 \\ 0 & 0 & R\end{matrix} ] [ \begin{matrix}{A}_{11} & {A}_{12} & 0 \\ {A}_{21} & {A}_{22} & {A}_{23} \\ 0 & {A}_{32} & {\overline{A}}_{33}\end{matrix} ]}^{- 1} [ \begin{matrix}I & 0 & 0 \\ 0 & I & 0 \\ 0 & 0 & P\end{matrix} ] , \\ P \text{:} u \to \overline{u} , R \text{:} \overline{u} \to u .$$

For example, if there are 100 variables that described the singularities, i.e., A₃₃ is 100×100 matrix, and they are approximated with an approximation that has 50 variables, the solution should define how to move from 100 to 50 variables and back. One possible action is ū_{3,1}=u_{3,1}+u_{3,2}, i.e., the first from the approximated variable is equal to the sum of the first two not approximated variables, and so on. In the other direction, u_{3,1}=ū_{3,1}, u_{3,2}=ū_{3,1}, i.e., the first two not approximated variables are equal to the first approximated variable, and so on.

It should be noted that if

$${M}_{RS}^{- 1} = {[ \begin{matrix}{A}_{11} & {A}_{12} \\ {A}_{21} & {A}_{22}\end{matrix} ]}^{- 1}$$

is used, then the convergence will depend on the mesh size and will deteriorate for large problems.

The multiplicative version is as follows:

u=0

u=M_{W}⁻¹(b−Au)

u+=M_{RS}⁻¹(b−Au).

The non-overlapping algorithm is a little more complicated. Suppose γ denotes the boundary of the singularities. Further suppose that either there are unknowns on the boundary or additional unknowns are introduced, and the resulting system Ã produces the same solution as A:

$$\tilde{A} = [ \begin{matrix}{\tilde{A}}_{11} & {\tilde{A}}_{1 γ} & 0 \\ {\tilde{A}}_{γ 1} & {\tilde{A}}_{γγ} & {\tilde{A}}_{γ 3} \\ 0 & {\tilde{A}}_{3 γ} & {\tilde{A}}_{33}\end{matrix} ] .$$

In certain embodiments, an extension operator e and its matrix representation E are introduced. The operator e starts from the boundary of the singularity and “extends” the solution inside it. It does not change anything outside the singularity. Mathematically, the extension operator e is defined as:

$$e [ \begin{matrix}{u}_{1} \\ {u}_{γ}\end{matrix} ] = [ \begin{matrix}{u}_{1} \\ {u}_{γ} \\ - {A}_{33}^{- 1} {A}_{3 γ} {u}_{γ}\end{matrix} ] = [ \begin{matrix}{I}_{1} & 0 \\ 0 & {I}_{γ} \\ 0 & {A}_{33}^{- 1} {A}_{3 γ}\end{matrix} ] \cdot [ \begin{matrix}{u}_{1} \\ {u}_{γ}\end{matrix} ] = E [ \begin{matrix}{u}_{1} \\ {u}_{γ}\end{matrix} ] , \\ {e}^{T} [ \begin{matrix}{u}_{1} \\ \begin{matrix}{u}_{γ} \\ {u}_{3}\end{matrix}\end{matrix} ] = {E}^{T} [ \begin{matrix}{u}_{1} \\ {u}_{γ} \\ {u}_{3}\end{matrix} ] .$$

The operator e^{T}, the transpose operator of e “extends” from the singularity to the interface without changing anything else.

Suppose A_{N} is a matrix from the approximation with Neumann boundary condition on γ. Then, M⁻¹u=EA_{N}⁻¹E^{T}+A₃₃⁻¹, i.e.,

M⁻¹u=x_{N}+x₃, EA_{N}⁻¹E^{T}x_{N}=u, A₃₃x₃=u₃. The multiplicative version also can be applied. The matrices A_{N}⁻¹ and A₃₃⁻¹ can be replaced by preconditioners, thereby constructing preconditioners based on this approximation of the singularity(ies).

Further, in certain embodiments, an algorithm that may be employed for constructing an alternative preconditioner when an approximation is not available or has unacceptable quality (e.g., as determined in blocks 701 or 703 of FIG. 7 discussed above). Thus, this exemplary second algorithm may be employed in block 73 of FIG. 7. Suppose the original algebraic system is Ku(A+13)u=b,

$$Ku = [ \begin{matrix}{A}_{11} + {B}_{11} & {B}_{12} \\ {B}_{21} & {B}_{22}\end{matrix} ] [ \begin{matrix}{u}_{1} \\ {u}_{γ}\end{matrix} ] = [ \begin{matrix}{b}_{1} \\ {b}_{2}\end{matrix} ] = b , \\ A = [ \begin{matrix}{A}_{11} & 0 \\ 0 & {A}_{22}\end{matrix} ] , B = [ \begin{matrix}{B}_{11} & {B}_{12} \\ {B}_{21} & {B}_{22} - {A}_{22}\end{matrix} ] ,$$

where the A₂₂ matrix is easily invertible and the rank of B is much smaller than the rank of K. The dimension of u₂ is much smaller than the dimension of u₁.

Define T=A⁻¹B, (I+T)u=g, g=A⁻¹b.

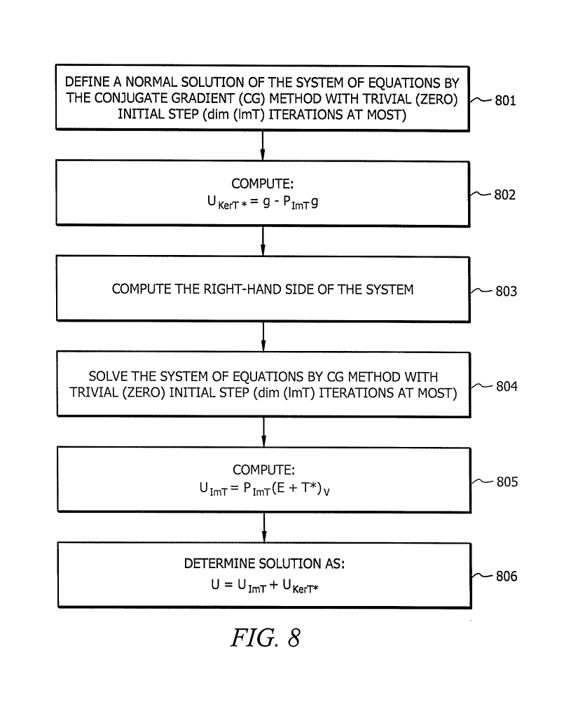

Thus, this exemplary second algorithm may be implemented by the self-adapting iterative solver 402 (e.g., for performance of block 73 of FIG. 7) according to the exemplary operational flow of FIG. 8. Consider that P_{ImT} denotes the orthogonal projector from R^{N} onto ImT. In block 801, the action of the operator P_{ImT} on an arbitrary vector w is defined as normal solution of the system of equations TT*w_{ImT}=TT*w, i.e., r=P_{ImT}w=TT*w. This can be done by any available method, for example using the conjugate gradient (CG) method with trivial (zero) initial step (dim (ImT) iterations at most). This is defined by the “good” part corresponding to the matrix A and the “bad” part corresponding to the matrix B. Certain embodiments may be implemented to first reduce the dimension of the “bad” part with an approximation of the singularity and using an algorithm of the first type.

In block 802, the self-adapting iterative solver 402 computes u_{KerT}_{^{*}}=g−P_{ImT}g.

In block 803, the self-adapting iterative solver 402 computes the right-hand side of the system: q=P_{ImT}g−T(g−P_{ImT}g).

In block 804, the self-adapting iterative solver 402 solves the system

(I+T)P_{ImT}(I+T*)v=q. This can be done by any method, for example by CG method with trivial (zero) initial step (dim (ImT) iterations at most), but for each iteration it multiplies by the operator P_{ImT}.

In block 805, the self-adapting iterative solver 402 computes u_{ImT}=P_{ImT}(I+T*)v. And, in block 806, the self-adapting iterative solver 402 determines the solution as u=u_{ImT}+u_{KerT}_{^{*}}.

Embodiments, or portions thereof, may be embodied in program or code segments operable upon a processor-based system (e.g., computer system) for performing functions and operations as described herein for the self-adapting iterative solver. The program or code segments making up the various embodiments may be stored in a computer-readable medium, which may comprise any suitable medium for temporarily or permanently storing such code. Examples of the computer-readable medium include such physical computer-readable media as an electronic memory circuit, a semiconductor memory device, random access memory (RAM), read only memory (ROM), erasable ROM (EROM), flash memory, a magnetic storage device (e.g., floppy diskette), optical storage device (e.g., compact disk (CD), digital versatile disk (DVD), etc.), a hard disk, and the like.

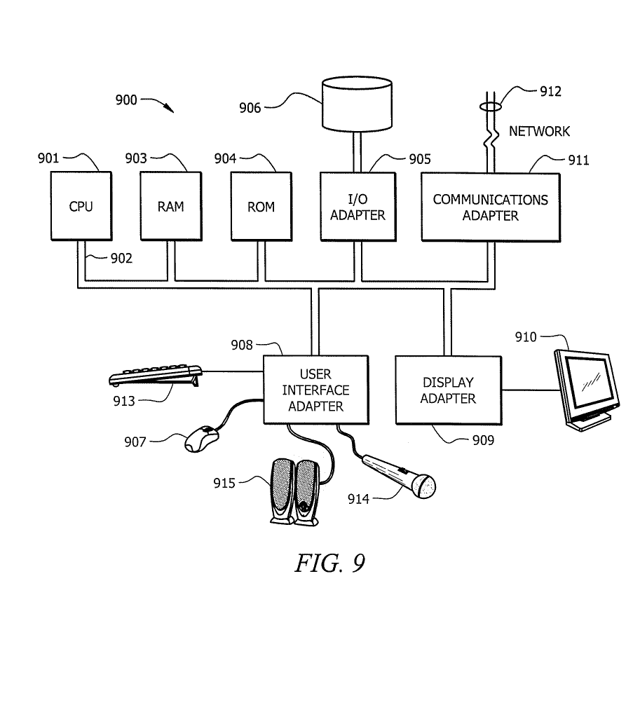

FIG. 9 illustrates an exemplary computer system 900 on which software for performing processing operations of the above-described self-adapting iterative solver according to embodiments of the present invention may be implemented. Central processing unit (CPU) 901 is coupled to system bus 902. CPU 901 may be any general-purpose CPU. The present invention is not restricted by the architecture of CPU 901 (or other components of exemplary system 900) as long as CPU 901 (and other components of system 900) supports the inventive operations as described herein. CPU 901 may execute the various logical instructions according to embodiments. For example, CPU 901 may execute machine-level instructions for performing processing according to the exemplary operational flows of embodiments of the self-adapting iterative solver as described above in conjunction with FIGS. 4-8.

Computer system 900 also preferably includes random access memory (RAM) 903, which may be SRAM, DRAM, SDRAM, or the like. Computer system 900 preferably includes read-only memory (ROM) 904 which may be PROM, EPROM, EEPROM, or the like. RAM 903 and ROM 904 hold user and system data and programs, as is well known in the art.

Computer system 900 also preferably includes input/output (I/O) adapter 905, communications adapter 911, user interface adapter 908, and display adapter 909. I/O adapter 905, user interface adapter 908, and/or communications adapter 911 may, in certain embodiments, enable a user to interact with computer system 900 in order to input information.

I/O adapter 905 preferably connects to storage device(s) 906, such as one or more of hard drive, compact disc (CD) drive, floppy disk drive, tape drive, etc. to computer system 900. The storage devices may be utilized when RAM 9703 is insufficient for the memory requirements associated with storing data for operations of embodiments of the present invention. The data storage of computer system 900 may be used for storing such information as a model (e.g., model 406 of FIGS. 4-6), a catalog of pre-identified possible singularities (e.g., catalog 505 of FIGS. 5-6), a list of singularities (e.g., list 506 of FIGS. 5-6), and/or other data used or generated in accordance with embodiments of the present invention. Communications adapter 911 is preferably adapted to couple computer system 900 to network 912, which may enable information to be input to and/or output from system 900 via such network 912 (e.g., the Internet or other wide-area network, a local-area network, a public or private switched telephony network, a wireless network, any combination of the foregoing). User interface adapter 908 couples user input devices, such as keyboard 913, pointing device 907, and microphone 914 and/or output devices, such as speaker(s) 915 to computer system 900. Display adapter 909 is driven by CPU 901 to control the display on display device 910 to, for example, display information pertaining to a model under analysis, such as displaying a generated 3D representation of fluid flow in a subsurface hydrocarbon bearing reservoir over time, according to certain embodiments.

It shall be appreciated that the present invention is not limited to the architecture of system 900. For example, any suitable processor-based device may be utilized for implementing all or a portion of embodiments of the present invention, including without limitation personal computers, laptop computers, computer workstations, and multi-processor servers. Moreover, embodiments may be implemented on application specific integrated circuits (ASICs) or very large scale integrated (VLSI) circuits. In fact, persons of ordinary skill in the art may utilize any number of suitable structures capable of executing logical operations according to the embodiments.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method comprising:
identifying, by a self-adapting iterative solver, at least one singularity present in a linear system of equations;
constructing, by said self-adapting iterative solver, a first preconditioner for use in solving said linear system of equations;
determining, by said self-adapting iterative solver, whether computational performance of the first preconditioner is acceptable; and
when determined that the computational performance of the first preconditioner is unacceptable, constructing, by said self-adapting iterative solver, an alternative preconditioner for use in solving said linear system of equations.

2. The method of claim 1 wherein the alternative preconditioner suppresses a determined bad part of the identified at least one singularity, thereby resulting in acceptable computational performance for a remaining good part of the identified at least one singularity.

3. The method of claim 2 wherein the alternative preconditioner comprises the first preconditioner employed for iteratively solving the remaining good part of the identified at least one singularity.

4. The method of claim 1 wherein said identifying comprises identifying a plurality of singularities, and wherein said first preconditioner is used for extracting some of the plurality of singularities for solving said linear system of equations, and wherein said alternative preconditioner is used for extracting a remaining portion of the plurality of singularities for solving said linear system of equations.

5. The method of claim 4 further comprising:
employing a deflation algorithm for extracting a further remaining portion of the plurality of singularities for solving said linear system of equations.

6. The method of claim 4 further comprising:
determining, by said self-adapting iterative solver, that an approximation is acceptably efficient for said at least some of the plurality of singularities; and
wherein said constructing said first preconditioner comprises constructing said first preconditioner based on said approximation.

7. The method of claim 6 further comprising:
determining, by said self-adapting iterative solver, that said approximation is not acceptably efficient for at least a second portion of the plurality of singularities.

8. The method of claim 6 wherein said constructing said alternative preconditioner comprises:
using deflation for constructing said alternative preconditioner for extracting said at least a second portion of the plurality of singularities.

9. A method comprising:
identifying, by a self-adapting iterative solver, a singularity present in a linear system of equations;
determining, by said self-adapting iterative solver, whether an acceptable approximation is available for the identified singularity;
when determined that there is not an acceptable approximation available for the identified singularity, extracting, by the self-adapting iterative solver, a bad portion of the identified singularity to result in a remaining good portion of the singularity for which an acceptable approximation is available; and
iteratively solving, by the self-adapting iterative solver, the approximation for the remaining good portion of the singularity.

10. The method of claim 9 wherein said determining whether an acceptable approximation is available for the identified singularity comprises:
constructing, by said self-adapting iterative solver, a first preconditioner for use in solving said linear system of equations; and
determining, by said self-adapting iterative solver, whether computational performance of the first preconditioner is acceptable.

11. The method of claim 10 further comprising:
when determined that the computational performance of the first preconditioner is unacceptable, constructing, by said self-adapting iterative solver, an alternative preconditioner for use in solving said remaining good portion of the singularity.

12. The method of claim 11 wherein said alternative preconditioner comprises the first preconditioner.

13. The method of claim 9 further comprising:
solving, by the self-adapting iterative solver, the extracted bad portion of the identified singularity.

14. Computer-executable software code stored to a computer-readable medium that, when executed by a computer, causes the computer to perform a method comprising:
identifying at least one singularity present in a linear system of equations;
determining an approximation of the at least one singularity;
constructing a first preconditioner based on the determined approximation for use by an iterative solver in solving said linear system of equations;
determining whether computational performance of the preconditioner is acceptable;
when determined that the computational performance of the preconditioner is unacceptable, constructing an alternative preconditioner for use by said iterative solver in solving said linear system of equations.

15. The computer-executable software code of claim 14 wherein the alternative preconditioner is not based on the determined approximation.

16. The computer-executable software code of claim 14 wherein the alternative preconditioner is constructed using deflation.

17. The computer-executable software code of claim 14 wherein said determining said approximation of the at least one singularity comprises determining whether an approximation is available for the at least one singularity; and wherein when determined that said approximation is not available for the at least one singularity, then constructing said alternative preconditioner for use by said iterative solver in solving said linear system of equations.

18. The computer-executable software code of claim 14 wherein said method further comprises:
wherein said identifying comprises identifying a plurality of singularities; and
wherein said determining an approximation comprises determining an approximation of at least a first one of the plurality of singularities.

19. The computer-executable software code of claim 18 wherein said method further comprises:
using, by said iterative solver, said first preconditioner for extracting said at least a first one of the plurality of singularities for solving said linear system of equations.

20. The computer-executable software code of claim 19 wherein said method further comprises:
using, by said iterative solver, said alternative preconditioner for extracting at least a second one of the plurality of singularities for solving said linear system of equations.

21. The computer-executable software code of claim 20 wherein said method further comprises:
determining that an approximation is not available for said at least a second one of the plurality of singularities.

22. The computer-executable software code of claim 14 wherein said method further comprises:
wherein said identifying comprises identifying a plurality of singularities present in said linear system of equations;
determining, for each of said plurality of singularities, whether a corresponding approximation is acceptably efficient; and
for each of said plurality of singularities for which a corresponding approximation is acceptably efficient, using the corresponding approximation to construct said first preconditioner for use by said iterative solver in extracting said singularities for which a corresponding approximation is available.

23. The computer-executable software code of claim 22 wherein said method further comprises:
constructing said alternative preconditioner for use by said iterative solver in extracting each of said plurality of singularities for which a corresponding approximation is determined not available.

24. A method comprising:
identifying, by a self-adapting iterative solver, a plurality of singularities present in a linear system of equations;
constructing, by said self-adapting iterative solver, a first preconditioner for extracting a first portion of the singularities for solving said linear system of equations, wherein said first preconditioner is based on an approximation of at least one of the plurality of singularities;
constructing, by said self-adapting iterative solver, a second preconditioner for extracting a second portion of the singularities for solving said linear system of equations, wherein said second preconditioner is not based on an approximation of at least one of the plurality of singularities; and
processing, by said self-adapting iterative solver, said first preconditioner and said second preconditioner for solving said linear system of equations.

25. The method of claim 24 wherein said second preconditioner is constructed using decomposition of the solution into a bad part and a remaining good part.

26. The method of claim 25 further comprising:
using a deflation algorithm for solving at least a portion of the linear system of equations.

27. A method comprising:
processing a received model by an iterative solver for solving a linear system of equations;
identifying, by said solver, at least one singularity;
determining, by said solver, whether to exclude one or more of said identified at least one singularity based on observed performance of the solver in solving said linear system of equations; and
when determined that one or more of said identified at least one singularity is to be excluded, said solver self-adapting to exclude said determined one or more of said identified at least one singularity.

28. The method of claim 27 wherein said self-adapting comprises constructing a preconditioner to exclude said determined one or more of said identified at least one singularity.

29. The method of claim 27 wherein said determining comprises:
said solver autonomously determining whether to exclude said one or more of said identified at least one singularity based on said observed performance.

30. A method comprising:
processing a received model by an iterative solver for solving a linear system of equations, said solver having a pre-defined expected number of iterations required for converging on a solution;
said solver identifying at least one singularity; and
said solver determining whether the identified at least one singularity results in an increase in a number of iterations required for said converging above the pre-defined expected number of iterations.

31. The method of claim 30 further comprising:
when determined that the at least one singularity results in an increase in the number of iterations required for said converging above the pre-defined expected number of iterations, said solver self-adapting to exclude said identified at least one singularity.

32. The method of claim 31 further comprising:
weighting the identified at least one singularity; and
determining whether to self-adapt to exclude the identified at least one singularity based at least in part on the weighting.

33. The method of claim 30 further comprising:
said solver determining whether to self-adapt its processing of the linear system of equations to exclude the identified at least one singularity.

34. The method of claim 33 further comprising:
determining a computation cost associated with excluding the identified at least one singularity; and
wherein said determining whether to self-adapt comprises balancing the determined computational cost against a determined increase in a number of iterations required for said converging.

35. The method of claim 30 further comprising:
the solver autonomously self-adapting its processing to selectively exclude one or more of the identified at least one singularity based at least in part on computational performance of the solver in converging on a solution.

36. A method comprises:
identifying, by a self-adapting iterative solver that is operable to employ an iterative method for solving a linear system of equations, possible singularities present in the linear system of equations;
analyzing, by said self-adapting iterative solver, computational performance for solving the linear system of equations; and
based on its computational performance, said self-adapting iterative solver self-adapting to a treatment of the possible singularities that provides a desired performance.

37. The method of claim 36 wherein said self-adapting to a treatment of the possible singularities comprises:
constructing a preconditioner for excluding select ones of the possible singularities.
